(19) United States
(12) Patent Application Publication
(10) Pub. No.: US 2015/0349892 A1
(43) Pub. Date: Dec. 3, 2015

(54) INTEGRATED ANALOG AND DIGITAL DISTRIBUTED ANTENNA SYSTEM (DAS) UTILIZING AN ALL FIBER OPTIC NETWORK

(71) Applicant: ADC Telecommunications, Inc., Berwyn, PA (US)

(72) Inventors: Larry G. Fischer, Waseca, MN (US); Dean Zavadsky, Shakopee, MN (US); Tony Lefebvre, Edina, MN (US)

(21) Appl. No.: 14/726,068

(22) Filed: May 29, 2015

Related U.S. Application Data
(60) Provisional application No. 62/005,426, filed on May 30, 2014.

(51) Int. Cl. H04B 10/2575; H04B 10/54

(52) U.S. Cl. CPC H04B 10/25759; H04B 10/54; H04W 88/085

(57) ABSTRACT

A system includes: hub configured to receive respective signal from one or more network devices, wherein hub is configured to convert combined signal containing respective signal from each network device into digital radio frequency (RF) signal; remote unit coupled to hub over first optical fiber communication medium to receive from hub optical signal representing digital RF signal, wherein remote unit is configured to recover digital RF signal from optical signal and to convert digital RF signal to analog RF signal; antenna unit coupled to remote unit over second optical fiber communication medium to receive from remote unit second optical signal representing at least portion of analog RF signal, wherein antenna unit is not co-located with remote unit; and antenna coupled to and co-located with antenna unit, wherein antenna is configured to radiate signal from frequency band in analog RF signal recovered by antenna unit from second optical signal.

### CROSS-REFERENCE TO RELATED APPLICATIONS

This application claims the benefit of U.S. Provisional Patent Application Serial No. 62/005,426 filed on May 30, 2014, which is hereby incorporated herein by reference.

### BACKGROUND

Distributed Antenna Systems (DAS) are used to distribute wireless signal coverage into buildings or other substantially closed environments. For example, a DAS may distribute antennas within a building. The antennas are typically connected to a radio frequency (RF) signal source, such as a service provider. Various methods of transporting the RF signal from the RF signal source to the antenna have been implemented in the art.

### SUMMARY

A system includes: a hub configured to receive a respective signal from one or more network devices, wherein the hub is configured to convert a combined signal containing the respective signal from each of the one or more network devices into a digital radio frequency signal; a remote unit coupled to the hub over a first optical fiber communication medium to receive from the hub an optical signal representing the digital radio frequency signal, wherein the remote unit is configured to recover the digital radio frequency signal from the optical signal and to convert the digital radio frequency signal to an analog radio frequency signal; an antenna unit coupled to the at least one remote unit over a second optical fiber communication medium to receive from the remote unit a second optical signal representing at least a portion of the analog radio frequency signal, wherein the antenna unit is not co-located with the remote unit; and an antenna coupled to and co-located with the antenna unit, wherein the antenna is configured to radiate a signal from a frequency band in the analog radio frequency signal recovered by the antenna unit from the second optical signal.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of one embodiment of an exemplary system.

FIG. 2 is a block diagram of one embodiment of an exemplary main hub.

FIG. 3 is a block diagram of one embodiment of an exemplary remote unit.

FIG. 4 is a block diagram of one embodiment of an exemplary antenna unit.

FIG. 5 is a block diagram of one embodiment of another exemplary main hub.

FIG. 6 is a block diagram of one embodiment of another exemplary remote unit.

FIG. 7 is a block diagram of one embodiment of another exemplary antenna unit.

FIG. 8 is a flow chart depicting one embodiment of an exemplary method of transporting RF signals in a distributed antenna system.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

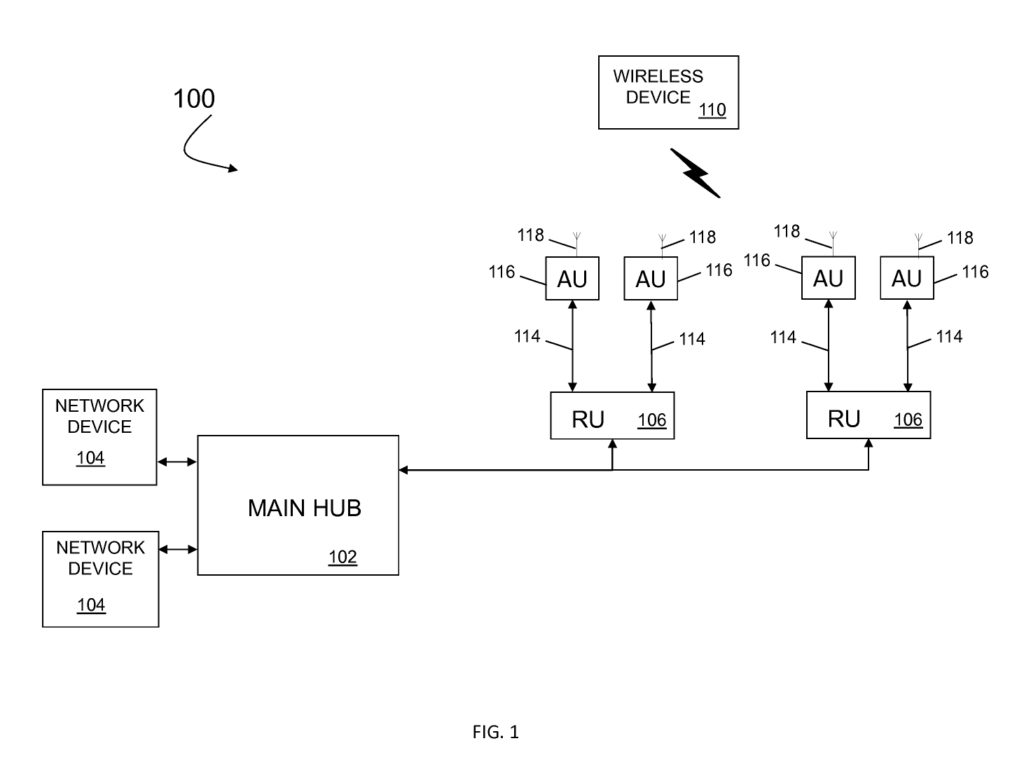

FIG. 1 is a block diagram of one embodiment of an exemplary distributed antenna system (DAS) 100 for distributing a radio frequency signal. The distributed antenna system 100 is used to transport radio frequency signals between one or more network devices 104 (such as base station transceivers or wireless access points or other sources of radio frequency signals) and one or more downstream wireless devices 110 (for example, mobile phones, mobile stations, fixed wireless modems, or other wireless devices). In some embodiments, the network devices 104 are a part of a telecommunication-service provider's infrastructure while the downstream devices 110 comprise customer premise equipment.

In general, for each radio frequency signal or channel over which a network device 104 communicates with a downstream wireless device 110, a downlink radio frequency signal is originally transmitted by the upstream network device 104 for reception by the downstream wireless device 110 and an uplink radio frequency signal is originally transmitted by the downstream wireless device 110 for reception by the upstream network device 104. The distributed antenna system (DAS) 100 is used to improve the wireless coverage of the upstream network devices 104. Additionally, the distributed antenna system 100 may include one or more of the following: filtering, amplification, wave division multiplexing, duplexing, synchronization, and monitoring functionality as needed.

The distributed antenna system 100 includes a first unit that is communicatively coupled to one or more second units (for example, directly or via one or more optional intermediate units). In the exemplary embodiment of FIG. 1, the first unit comprises a main hub 102 and the second unit comprises a remote unit (RU) 106. In this example, the remote unit 106 is coupled directly to the main hub 102 via communication link 112. However, it is to be understood that, in other embodiments, an intermediate unit, such as an expansion hub or a repeater can be included between the main hub 102 and the remote unit 106. Notably, although only two remote units 106 are shown in this example, for purposes of explanation, other numbers of remote units 106 can be used in other embodiments. For example, in some embodiments, up to eight remote units 106 are coupled to the main hub 102. In other embodiment, any number of remote units 106 are coupled to any number of main hubs 102.

In the particular embodiment shown in FIG. 1, the main hub 102 is communicatively coupled to the remote unit 106 via communication link 112. For example, in one embodiment described here in connection with FIG. 1, the communication link 112 comprises one or more fiber optic cables. In some embodiments, each communication link 112 includes a separate optic fiber for the downlink and uplink signals. However, in other embodiments, a wavelength division multiplexing (WDM) optical combiner is used in order to use a single fiber for both the uplink and downlink signals of communication link 112.

The main hub 102 is communicatively coupled to one or more upstream network devices 104 (such as base stations or wireless access points). In some embodiments, the main hub 102 is physically connected to the one or more upstream network devices 104. In other embodiments, the main hub 102 is communicatively coupled to the one or more upstream network devices 104 in other ways. For example, in some embodiments, one or more donor antennas and one or more bi-directional amplifiers or repeaters are used to wirelessly send and receive radio frequency (RF) signals from the network devices 104 to the main hub 102.

As described in more detail below, the main hub 102 is configured to digitize the RF signals received from the network devices 104 and to transmit the digitized signals over communication link 112 (such as an optical fiber) to the remote units 106. The remote units 106, in turn, are configured to convert the digitized RF signals to analog RF signals and then to transport the analog signals over an optical fiber 114 to respective antenna units 116. Each respective antenna unit 116 converts the analog optical signals to analog radio frequency signals and provides the analog RF signals to the respective antenna 118 for wireless transmission to one or more wireless devices 110.

A similar process occurs in the upstream direction, as described in more detail below. For example, a wireless RF signal from the wireless device 110 is received at an antenna 118 of one or more of the antenna units 116. The antenna unit 116 converts the received analog RF to an analog optical signal and transmits the analog optical signal over optical fiber 114 to the respective remote unit 106. The remote unit 106 converts the received analog optical signal to a digital optical signal and transmits the digital optical signal to the main hub 102. The main hub 102 converts the digital optical signal to an analog RF signal and provides the analog RF signal to the respective network device 104.

Through the use of separate antenna units 116 and remote units 106, as described herein, the distributed antenna system 100 enables various advantages over conventional distributed antenna systems. For example, less equipment needs to be co-located with an antenna on a tower or ceiling. As used herein, the term “co-located” means located in close proximity to each other. For example, co-located includes being located on the same tower, in the same housing, etc. Additionally, the distributed antenna system 100 enables the use of broadband equipment which allows for easier reconfiguration of the system. Additionally, relatively low cost optics can be used for the analog links between the remote unit 106 and the respective antenna units 116. The analog and digital links can also transport the signals at the corresponding RF frequency to avoid the cost of up and down conversion.

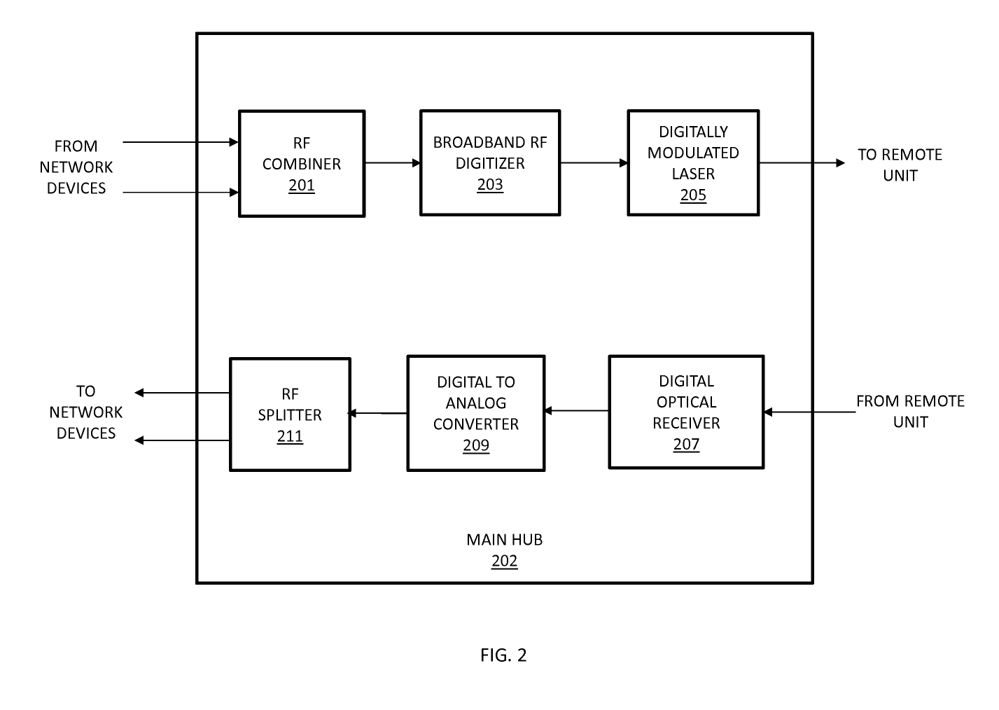

FIG. 2 is a block diagram of one embodiment of a main hub 202 which can be used in distributed antenna system 100. In exemplary embodiments, the main hub 102 of distributed antenna system 100 is implemented by a main hub 202. It is to be understood that the main hub 202 is provided by way of example only. For example, additional components not shown or described herein can be included in implementing a main hub 202. In this embodiment, the main hub 202 is coupled to a plurality of network devices (such as network devices 104 described above with reference to FIG. 1). Hence, in this embodiment, main hub 202 includes an RF combiner 201 which combines the RF signals from the respective network devices into a single combined RF signal. For example, each network device can be configured to operate over a different, non-overlapping frequency band. The frequency bands can then be combined in the RF combiner 201 with approximately no interference since the bands do not overlap. In one embodiment, the spectrum of the combined signal includes a frequency spectrum of approximately 800-2500 MHz.

The combined RF signal is provided to a broadband RF digitizer 203 (also referred to as a broadband RF analog-to-digital converter) which is configured to digitize the entire RF spectrum of the combined RF signal. Additionally, in some embodiments, the broadband RF digitizer 203 can be configured to filter frequencies which are not within the spectrum of interest. The digitized RF signal is then provided to the digitally modulated laser 205 for transmission as an optical signal over optic fiber to one or more remote units (such as remote units 106 described above with reference to FIG. 1).

In the upstream direction from the wireless devices to the network devices, the main hub 202 includes a digital optical receiver 207 to receive an optical signal from one or more remote units (such as remote units 106 described above with reference to FIG. 1). The digital optical receiver 207 converts the optical signal to a digital RF signal. The digital RF signal is then converted to an analog RF signal in the digital to analog converter 209. The analog RF signal is then split in the RF splitter 211 based on the respective frequency bands with correspond to respective network devices. Each of the split RF frequency bands is then sent to the respective network device (such as a network device 104 described above with reference to FIG. 1).

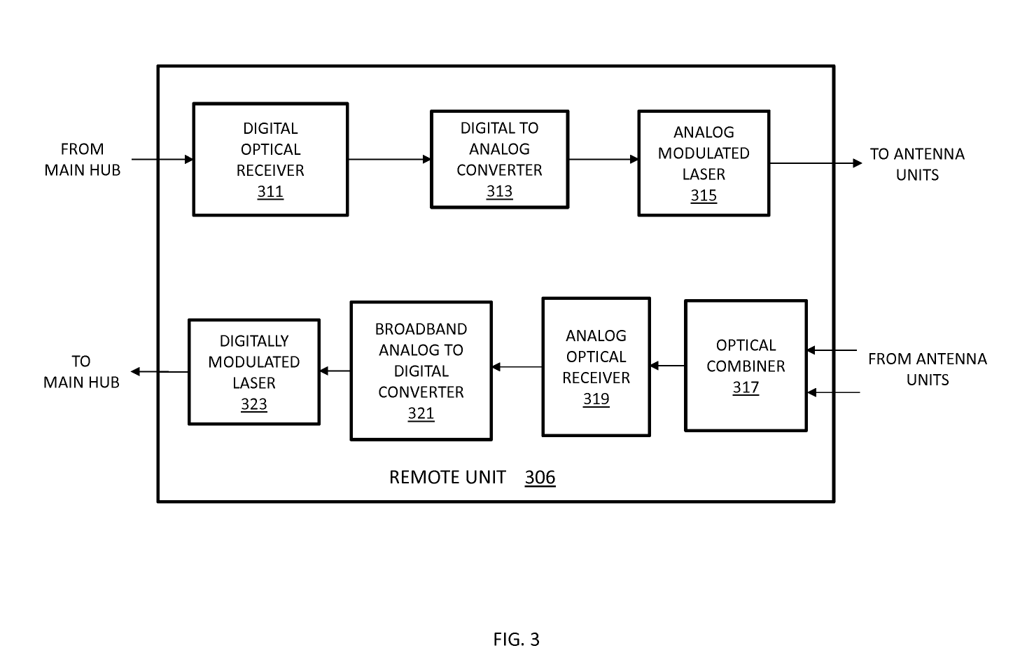

FIG. 3 is a block diagram of one embodiment of an exemplary remote unit 306 which can be implemented in a distributed antenna system, such as distributed antenna system 100. In exemplary embodiments, a remote unit 106 of distributed antenna system 100 is implemented by a remote unit 306. Remote unit 306 includes a digital optical receiver 311 which is configured to convert a digital optical signal received from a main hub into a digital RF signal. The digital RF signal is then converted to an analog RF signal in digital to analog converter 313. The analog RF signal is then passed to an analog modulated laser 315 which outputs the analog RF signal as an optical signal for transmission to one or more antenna units over optical fiber. Thus, in this example, the remote unit 306 transmits the entire RF spectrum of the analog RF signal to each of the antenna units (such as antenna units 116 described above with reference to FIG. 1).

The remote unit 306 also includes, in this example, an optical combiner 317 to combine optical signals received from the antenna units (such as antenna units 116 described above with reference to FIG. 1) coupled to the remote unit 306. The output of the optical combiner 317 is converted to an analog RF signal in the analog optical receiver 319. The analog RF signal is then converted to a digital RF signal in the broadband analog to digital converter 321. The digital RF signal is then converted to an optical signal in the digitally modulated laser 323 for transmission over optical fiber to the main hub.

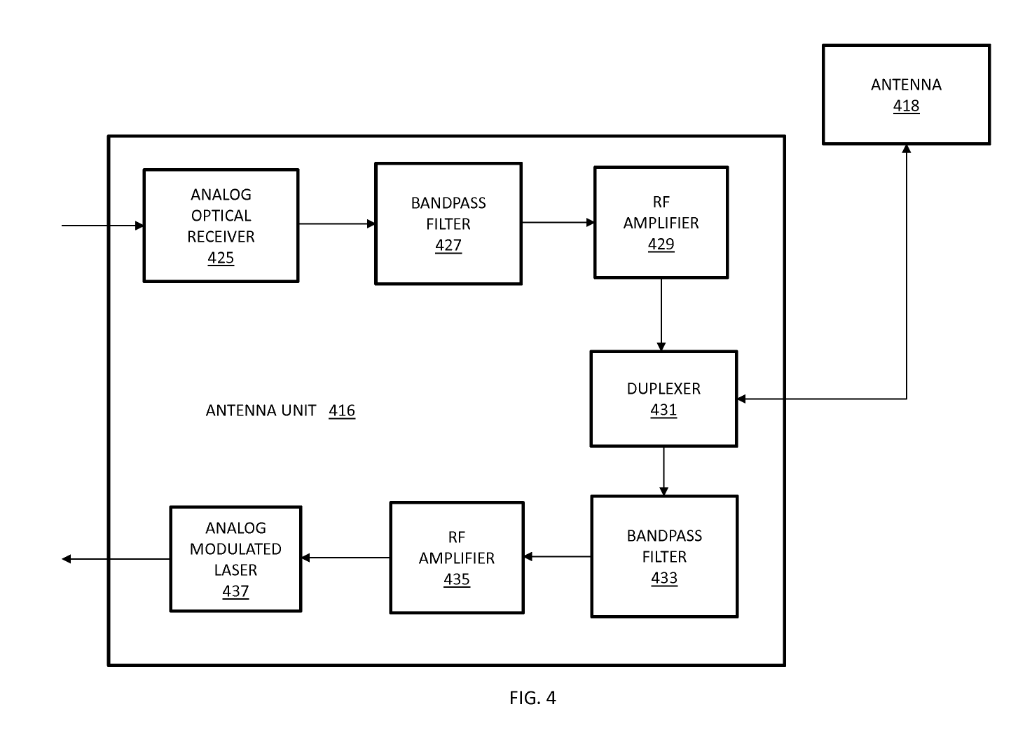

FIG. 4 is a block diagram of one embodiment of an exemplary antenna unit 416 which can be implemented in a distributed antenna system, such as distributed antenna system 100 described above. In exemplary embodiments, an antenna unit 116 of distributed antenna system 100 is implemented by an antenna unit 416. The antenna unit 416 includes an analog optical receiver 425 which converts the optical signal received from the remote unit into an analog RF signal. In this example, the antenna unit 416 receives other frequencies bands in addition to the corresponding frequency band of the antenna unit. In particular, as described with respect to FIG. 3, in some embodiments, the remote unit (such as remote unit 106 described above with reference to FIG. 1) does not filter or select which frequency band to send to each antenna unit (such as antenna units 116 described above with reference to FIG. 1). Rather the remote unit (such as remote unit 106 described above with reference to FIG. 1), in such embodiments, sends the entire received RF spectrum to each of the antenna units (such as antenna units 116 described above with reference to FIG. 1).

Hence, in this embodiment, the antenna unit 416 includes a bandpass filter 427 to isolate the desired frequency band and filter out unwanted signals. For example, the bandpass filter 427 can be implemented as a plug-in or swappable filter for ease of customizing the antenna unit 416. The filtered analog RF signal is then amplified in an RF amplifier 429 (such as a power amplifier). It is to be understood that in other embodiments, the RF signal is first amplified and then filtered. The amplified and filtered RF signal is then provided to an antenna 418 via a duplexer 431 for wireless transmission to one or more wireless devices (such as wireless device 110 described above with reference to FIG. 1).

In this embodiment, the antenna unit 416 also includes a second bandpass filter 433 coupled to the duplexer 431 to receive analog RF signals from the antenna 418. The second bandpass filter 433 is configured to filter out unwanted signals in the received analog RF signal. However, it is to be understood that in other embodiments, the second bandpass filter 433 is omitted. The filtered analog RF signal is then amplified in an optional second RF amplifier 435. The amplified analog RF signal is then converted to an optical signal by the analog modulated laser 437 for transmission to the remote unit (such as remote unit 106 described above with reference to FIG. 1).

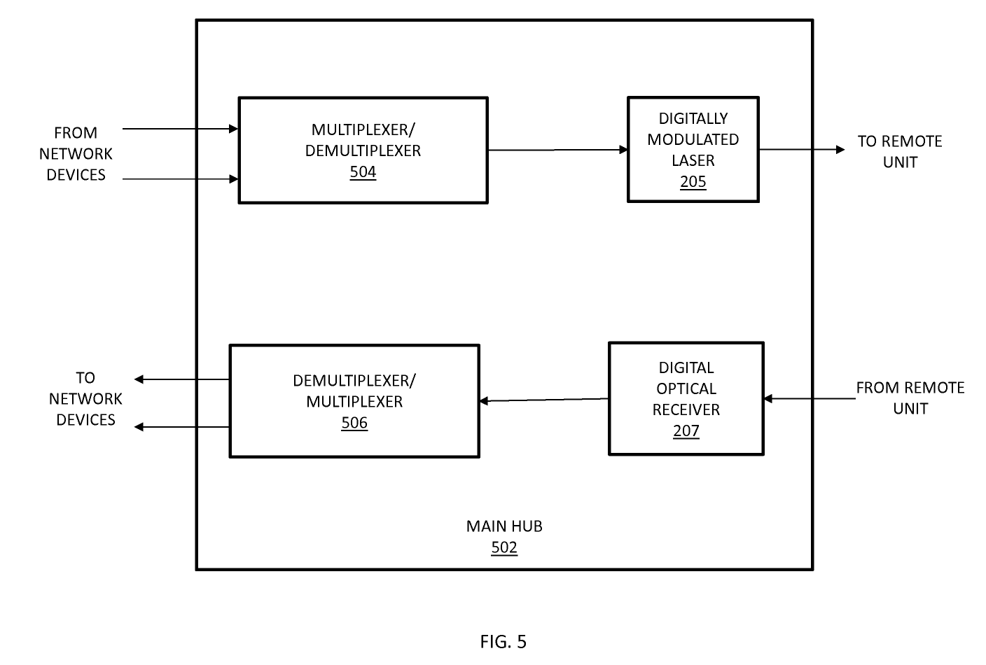

FIG. 5 is a block diagram of one embodiment of another exemplary main hub 502. In exemplary embodiments, a main hub 102 of distributed antenna system 100 is implemented by a main hub 502. The main hub 502 is similar to the main hub 202, but rather than interface with the network devices (such as network devices 104 described above with reference to FIG. 1) using RF signals, main hub 502 interfaces with the network devices (such as network devices 104 described above with reference to FIG. 1) using digital baseband signals, such as Common Public Radio Interface (CPRI) signals, Open Base Station Architecture Initiative (OBSAI) signals, and/or Open Radio Interface (ORI) signals. In exemplary embodiments, the network interfaces (such as network devices 104 described above with reference to FIG. 1) to which the main hub 502 is coupled are at least one of Common Public Radio Interface (CPRI) base station interfaces, an Open Base Station Architecture Initiative (OBSAI) base station interfaces, and an Open Radio Interface (ORI) base station interfaces. Main hub 502 includes digitally modulated laser 205 and digital optical receiver 207.

However, in contrast to main hub 202, main hub 502 does not include RF combiner 201, broadband RF digitizer 203, digital to analog converter 209, or RF splitter 208. Instead, the main hub 502 includes a multiplexer/demultiplexer 504 (such as a framer) configured to convert digital baseband signals received from the network devices (such as network devices 104 described above with reference to FIG. 1) into a combined digitized broadband signal used within the distributed antenna system 100. The combined digitized broadband signal is then provided to the digitally modulated laser 205 for transmission as an optical signal over optic fiber to one or more remote units (such as remote units 106 described above with reference to FIG. 1). Similarly, main hub 502 includes demultiplexer/multiplexer 506 (such as a de-framer) configured to convert an uplink digitized broadband signal received via the digital optical receiver 207 from one or more remote units (such as remote units 106 described above with reference to FIG. 1) into digital baseband signals that are then communicated to the network devices (such as network devices 104 described above with reference to FIG. 1).

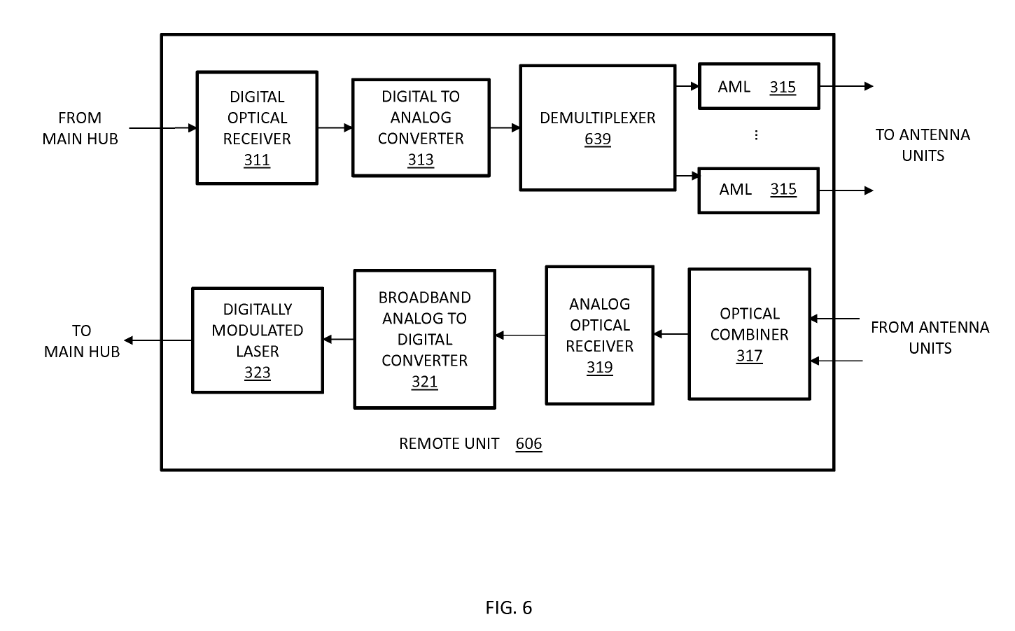

FIG. 6 is a block diagram of another exemplary remote unit 606. In exemplary embodiments, a remote unit 106 of distributed antenna system 100 is implemented by a remote unit 606. The remote unit 606 is similar to the remote unit 306. Remote unit 606 includes digital optical receiver 311, digital to analog converter 313, a plurality of analog modulated lasers 315, optical combiner 317, analog optical receiver 319, broadband analog to digital converter 321, and digitally modulated laser 323 which operate as described above with reference to the remote unit 306. However, the remote unit 606 includes a demultiplexer 639 which receives the analog RF signal output from the digital to analog converter 313. The demultiplexer 639 separates each respective frequency band from the combined analog RF signal. Each respective frequency band is provided to a respective analog modulated laser 315 coupled to an antenna unit (such as antenna units 116 described above with reference to FIG. 1) corresponding to the respective frequency band.

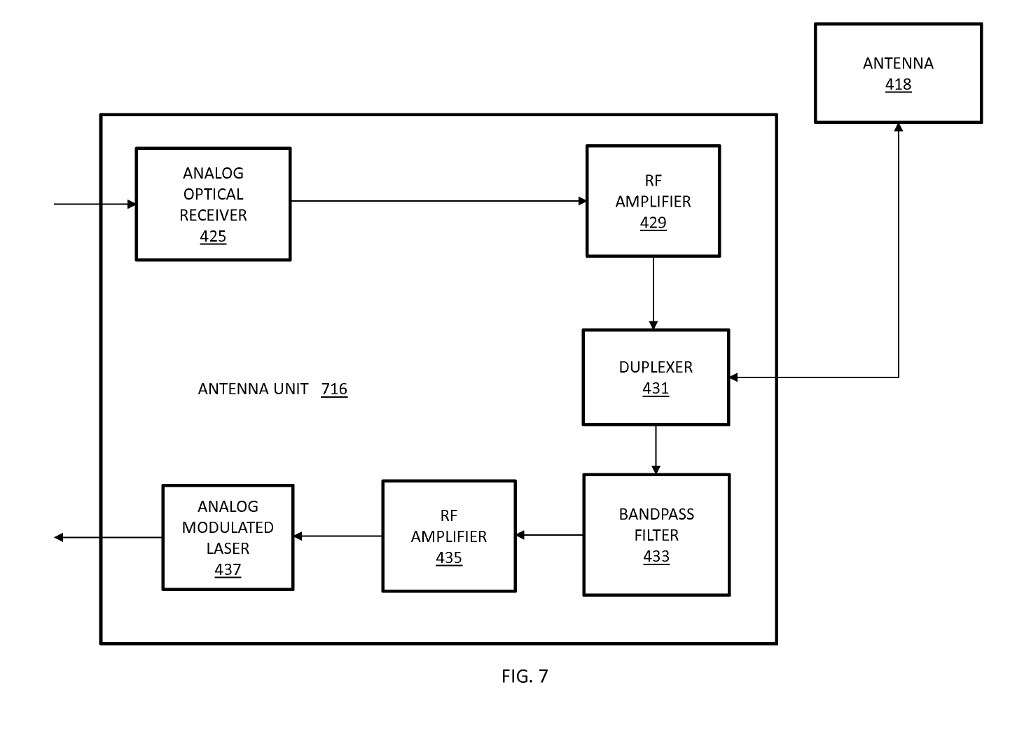

FIG. 7 is a block diagram of another exemplary antenna unit 716 for use with a remote unit, such as remote unit 606, which separates the respective frequency bands of a broadband analog RF signal that correspond to the respective antenna units. However, it is to be understood that other antenna units, such as antenna unit 416, can also be used with remote units, such as remote unit 606. In the example of FIG. 7, antenna unit 716 includes analog optical receiver 425, RF amplifier 429, duplexer 431, bandpass filter 433, RF amplifier 435, and analog modulated laser 437, but antenna unit 716 does not include a bandpass filter, such as bandpass filter 427 in FIG. 4, to filter the RF signal received from the remote unit. Thus, the analog RF signal is applied directly to the RF amplifier 429 from the analog optical receiver 425. The other elements of antenna unit 716 operate similarly to the corresponding elements described above with respect to antenna unit 416 in FIG. 4.

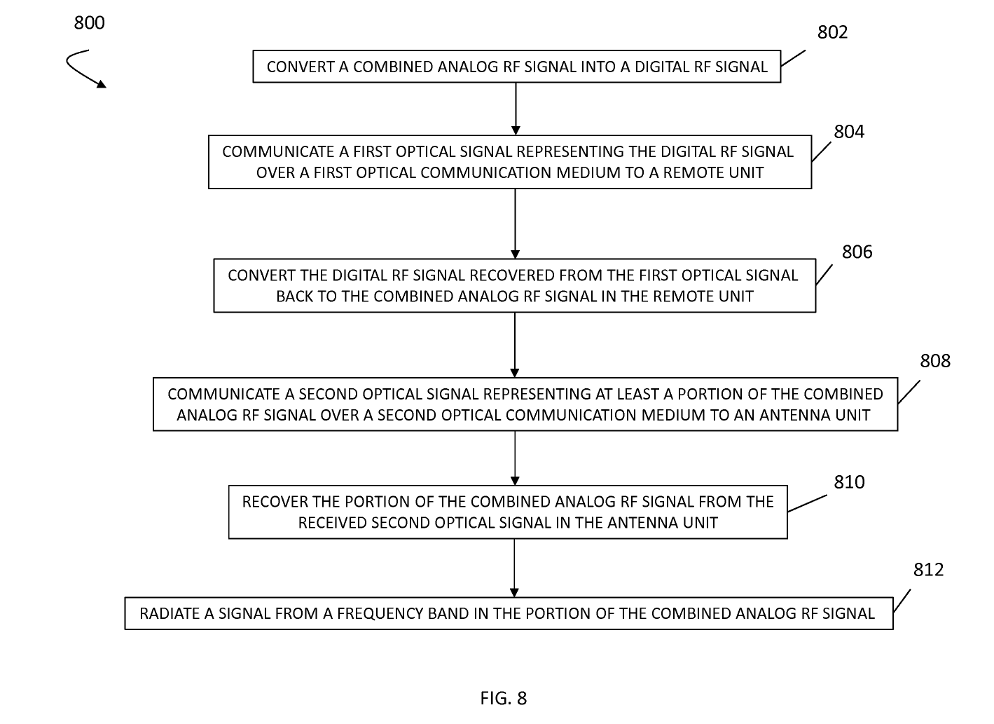

FIG. 8 is a flow chart depicting one embodiment of a method 800 of transporting RF signals in a distributed antenna system. At block 802, a combined analog RF signal containing a respective RF signal from each of one or more network devices is converted into a digital RF signal at a hub or host unit. In some embodiments, the hub or host unit receives the combined analog RF signal. In other embodiments, the hub receives the individual RF signals and combines them into the combined analog RF signal. At block 804, the combined analog RF signal is converted to an optical signal and communicated over an optical communication medium to a remote unit as discussed above. At block 806, the digital RF signal is recovered from the optical signal at the remote unit and converted back to the combined analog RF signal. At block 808, at least a portion of the combined analog RF signal is converted to an optical signal and communicated over another optical communication medium to an antenna unit that is not co-located with the remote unit. In some embodiments, the remote unit converts the entire spectrum of the combined analog RF signal to an optical signal for communication to one or more antenna units. In other embodiments, the remote unit separates the combined analog RF signal into frequency bands. Each frequency band corresponds to a respective antenna for radiation to a wireless device.

At block 810, the antenna unit recovers the portion of the combined analog RF signal transmitted from the remote unit over the optical communication medium. For example, in embodiments in which the remote unit transmits the entire RF spectrum, the antenna unit recovers the entire spectrum of the combined analog RF signal. In such embodiments, the antenna unit filters the combined analog RF signal to select the frequency band corresponding to the antenna co-located with and coupled to the antenna unit. For some embodiments in which the remote unit only transmits the corresponding frequency band, the antenna unit does not filter the recovered portion of the combined analog RF signal. In addition, in some embodiments, the antenna unit amplifies the frequency band corresponding to the co-located antenna. At block 812, the antenna radiates a signal from the corresponding frequency band of the combined analog RF signal received from the antenna unit.

In exemplary embodiments, at least some of the system components described herein are implemented in whole or in part using processors that may include or function with software programs, firmware or other computer readable instructions for carrying out various methods, process tasks, calculations, and control functions, used in the digital processing functionality described herein. These instructions are typically stored on any appropriate computer readable medium used for storage of computer readable instructions or data structures. The computer readable medium can be implemented as any available media that can be accessed by a general purpose processor (GPP) or special purpose computer or processor (such as a field-programmable gate array (FPGA), application-specific integrated circuit (ASIC) or other integrated circuit), or any programmable logic device. Suitable processor-readable media may include storage or memory media such as magnetic or optical media. For example, storage or memory media may include conventional hard disks, Compact Disk—Read Only Memory (CD- ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

### Example Embodiments

Example 1 includes a system comprising: a hub configured to receive a respective signal from one or more network devices, wherein the hub is configured to convert a combined signal containing the respective signal from each of the one or more network devices into a digital radio frequency signal; a remote unit coupled to the hub over a first optical fiber communication medium to receive from the hub an optical signal representing the digital radio frequency signal, wherein the remote unit is configured to recover the digital radio frequency signal from the optical signal and to convert the digital radio frequency signal to an analog radio frequency signal; an antenna unit coupled to the at least one remote unit over a second optical fiber communication medium to receive from the remote unit a second optical signal representing at least a portion of the analog radio frequency signal, wherein the antenna unit is not co-located with the remote unit; and an antenna coupled to and co-located with the antenna unit, wherein the antenna is configured to radiate a signal from a frequency band in the analog radio frequency signal recovered by the antenna unit from the second optical signal.

Example 2 includes the system of Example 1, wherein the respective signal from one or more network devices is a respective radio frequency signal.

Example 3 includes the system of Example 2, wherein the hub is configured to combine the respective radio frequency signal from each of the one or more network devices into the combined signal.

Example 4 includes the system of any of Examples 2-3, wherein the hub comprises: a broadband radio frequency digitizer configured to digitize the combined radio frequency signal; and a digitally modulated laser configured to convert the digitized radio frequency signal to a digital optical signal.

Example 5 includes the system of any of Examples 1-4, wherein the remote unit is configured to communicate the entire analog radio frequency signal to the antenna unit.

Example 6 includes the system of Example 5, wherein the antenna unit is configured to filter the analog radio frequency signal to select a frequency band corresponding to the antenna.

Example 7 includes the system of any of Examples 1-6, wherein the remote unit is configured to separate the analog radio frequency signal into a plurality of frequency bands and to communicate to the antenna unit one of the frequency bands corresponding to the antenna coupled to the antenna unit.

Example 8 includes the system of any of Examples 1-7, wherein the antenna unit is configured to amplify a frequency band corresponding to the antenna prior to providing the frequency band to the antenna.

Example 9 includes the system of any of Examples 1-8, wherein the combined signal includes a frequency spectrum of approximately 800-2500 MHz.

Example 10 includes the system of any of Examples 1-9, wherein the remote unit comprises: a digital optical receiver configured to receive a digital optical signal from the hub and to convert the digital optical signal to a digital radio frequency signal; a digital to analog converter configured to convert the digital radio frequency signal to an analog radio frequency signal; and an analog modulated laser configured to convert the analog radio frequency signal to an analog optical signal.

Example 11 includes the system of any of Examples 1-10, wherein the remote unit comprises: a digital optical receiver configured to receive a digital optical signal from the hub and to convert the digital optical signal to a digital radio frequency signal; a digital to analog converter configured to convert the digital radio frequency signal to an analog radio frequency signal; a demultiplexer configured to split the analog radio frequency signal into a plurality of non-overlapping frequency bands; and a plurality of analog modulated lasers, each analog modulated laser corresponding to a respective one of the plurality of non-overlapping frequency bands and to a respective one of a plurality of antenna units.

Example 12 includes the system of any of Examples 1-11, wherein the antenna unit comprises: an analog optical receiver configured to receive an analog optical signal from the remote unit and to convert the analog optical signal to an analog radio frequency signal; a bandpass filter configured to isolate a desired frequency band and filter unwanted signals; and an amplifier configured to amplify the isolated frequency band.

Example 13 includes the system of any of Examples 1-12, wherein the respective signal from one or more network devices is a digital baseband signal.

Example 14 includes the system of Example 13, wherein the hub is configured to multiplex the digital baseband signal from each of the one or more network devices into the combined signal.

Example 15 includes a remote unit for a distributed antenna system, the remote unit comprising: a digital optical receiver configured to receive a digital optical signal from a hub in the distributed antenna system, the digital optical receiver configured to convert the digital optical signal to a digital radio frequency signal; a digital to analog converter configured to convert the digital radio frequency signal to an analog radio frequency signal; and at least one analog modulated laser configured to convert the analog radio frequency signal to an analog optical signal for transmission to an antenna unit that is co-located with an antenna and is not co-located with the remote unit.

Example 16 includes the remote unit of Example 15, further comprising: a demultiplexer configured to split the analog radio frequency signal into a plurality of non-overlapping frequency bands; and a plurality of analog modulated lasers, each analog modulated laser corresponding to a respective one of the plurality of non-overlapping frequency bands and to a respective one of a plurality of antenna units, wherein each analog modulated laser is configured to convert the corresponding non-overlapping frequency band of the analog radio frequency signal to an analog optical signal for transmission to the respective antenna unit that is co-located with a respective antenna and is not co-located with the remote unit.

Example 17 includes the remote unit of any of Examples 15-16, further comprising: an optical combiner configured to combine a plurality of optical signals, each optical signal received from a corresponding one of a plurality of antenna units; an analog optical receiver configured to convert the combined optical signal to an analog radio frequency signal; a broadband analog to digital converter configured to convert the analog radio frequency signal to a digital radio frequency signal; and a digitally modulated laser configured to convert the digital radio frequency signal to an optical signal representing the digital radio frequency signal for transmission to the hub of the distributed antenna system.

Example 18 includes a method of communicating radio frequency signals through a distributed antenna system, the method comprising: converting a combined signal containing a respective signal from each of one or more network devices into a digital radio frequency signal; communicating a first optical signal representing the digital radio frequency signal over a first optical communication medium to a remote unit; converting the digital radio frequency signal recovered from the first optical signal back to the combined analog radio frequency signal in the remote unit; communicating a second optical signal representing at least a portion of the combined analog radio frequency signal over a second optical communication medium to an antenna unit co-located with an antenna, wherein the antenna unit is not co-located with the remote unit; and recovering the at least a portion of the combined analog radio frequency signal from the received second optical signal in the antenna unit; and radiating, with the antenna, a signal from a frequency band in the at least a portion of the combined analog radio frequency signal recovered by the antenna unit from the second optical signal.

Example 19 includes the method of Example 18, wherein the combined signal is a combined analog radio frequency signal; and wherein the respective signal from each of one or more network devices is a respective radio frequency signal from each of one or more network devices.

Example 20 includes the method of Example 19, further comprising: receiving a plurality of radio frequency signals from a plurality of network devices; and combining the plurality of radio frequency signals into the combined analog radio frequency signal.

Example 21 includes the method of any of Examples 18-20, wherein the second optical signal represents the entire spectrum of the combined analog radio frequency signal.

Example 22 includes the method of Example 21, further comprising filtering the combined analog radio frequency signal recovered from the second optical signal in the antenna unit to select the frequency band corresponding to the antenna.

Example 23 includes the method of any of Examples 18-22, further comprising separating the combined analog radio frequency signal into a plurality of frequency bands in the remote unit, wherein the second optical signal represents the frequency band corresponding to the antenna.

Example 24 includes the method of any of Examples 18-23, further comprising amplifying, in the antenna unit, the frequency band in the at least a portion of the combined analog radio frequency signal recovered by the antenna unit from the second optical signal.

What is claimed is:

1. A system comprising:
a hub configured to receive a respective signal from one or more network devices, wherein the hub is configured to convert a combined signal containing the respective signal from each of the one or more network devices into a digital radio frequency signal;
a remote unit coupled to the hub over a first optical fiber communication medium to receive from the hub an optical signal representing the digital radio frequency signal, wherein the remote unit is configured to recover the digital radio frequency signal from the optical signal and to convert the digital radio frequency signal to an analog radio frequency signal;
an antenna unit coupled to the at least one remote unit over a second optical fiber communication medium to receive from the remote unit a second optical signal representing at least a portion of the analog radio frequency signal, wherein the antenna unit is not co-located with the remote unit; and
an antenna coupled to and co-located with the antenna unit, wherein the antenna is configured to radiate a signal from a frequency band in the analog radio frequency signal recovered by the antenna unit from the second optical signal.

2. The system of claim 1, wherein the respective signal from one or more network devices is a respective radio frequency signal.

3. The system of claim 2, wherein the hub is configured to combine the respective radio frequency signal from each of the one or more network devices into the combined signal.

4. The system of claim 2, wherein the hub comprises:
a broadband radio frequency digitizer configured to digitize the combined radio frequency signal; and
a digitally modulated laser configured to convert the digitized radio frequency signal to a digital optical signal.

5. The system of claim 1, wherein the remote unit is configured to communicate the entire analog radio frequency signal to the antenna unit.

6. The system of claim 5, wherein the antenna unit is configured to filter the analog radio frequency signal to select a frequency band corresponding to the antenna.

7. The system of claim 1, wherein the remote unit is configured to separate the analog radio frequency signal into a plurality of frequency bands and to communicate to the antenna unit one of the frequency bands corresponding to the antenna coupled to the antenna unit.

8. The system of claim 1, wherein the antenna unit is configured to amplify a frequency band corresponding to the antenna prior to providing the frequency band to the antenna.

9. The system of claim 1, wherein the combined signal includes a frequency spectrum of approximately 800-2500 MHz.

10. The system of claim 1, wherein the remote unit comprises:
a digital optical receiver configured to receive a digital optical signal from the hub and to convert the digital optical signal to a digital radio frequency signal;
a digital to analog converter configured to convert the digital radio frequency signal to an analog radio frequency signal; and
an analog modulated laser configured to convert the analog radio frequency signal to an analog optical signal.

11. The system of claim 1, wherein the remote unit comprises:
a digital optical receiver configured to receive a digital optical signal from the hub and to convert the digital optical signal to a digital radio frequency signal;
a digital to analog converter configured to convert the digital radio frequency signal to an analog radio frequency signal;
a demultiplexer configured to split the analog radio frequency signal into a plurality of non-overlapping frequency bands; and
a plurality of analog modulated lasers, each analog modulated laser corresponding to a respective one of the plurality of non-overlapping frequency bands and to a respective one of a plurality of antenna units.

12. The system of claim 1, wherein the antenna unit comprises:
an analog optical receiver configured to receive an analog optical signal from the remote unit and to convert the analog optical signal to an analog radio frequency signal;
a bandpass filter configured to isolate a desired frequency band and filter unwanted signals; and
an amplifier configured to amplify the isolated frequency band.

13. The system of claim 1, wherein the respective signal from one or more network devices is a digital baseband signal.

14. The system of claim 13, wherein the hub is configured to multiplex the digital baseband signal from each of the one or more network devices into the combined signal.

15. A remote unit for a distributed antenna system, the remote unit comprising:
a digital optical receiver configured to receive a digital optical signal from a hub in the distributed antenna system, the digital optical receiver configured to convert the digital optical signal to a digital radio frequency signal;
a digital to analog converter configured to convert the digital radio frequency signal to an analog radio frequency signal; and
at least one analog modulated laser configured to convert the analog radio frequency signal to an analog optical signal for transmission to an antenna unit that is co-located with an antenna and is not co-located with the remote unit.

16. The remote unit of claim 15, further comprising:
a demultiplexer configured to split the analog radio frequency signal into a plurality of non-overlapping frequency bands; and
a plurality of analog modulated lasers, each analog modulated laser corresponding to a respective one of the plurality of non-overlapping frequency bands and to a respective one of a plurality of antenna units,
wherein each analog modulated laser is configured to convert the corresponding non-overlapping frequency band of the analog radio frequency signal to an analog optical signal for transmission to the respective antenna unit that is co-located with a respective antenna and is not co-located with the remote unit.

17. The remote unit of claim 15, further comprising:
an optical combiner configured to combine a plurality of optical signals, each optical signal received from a corresponding one of a plurality of antenna units;
an analog optical receiver configured to convert the combined optical signal to an analog radio frequency signal;
a broadband analog to digital converter configured to convert the analog radio frequency signal to a digital radio frequency signal; and
a digitally modulated laser configured to convert the digital radio frequency signal to an optical signal representing the digital radio frequency signal for transmission to the hub of the distributed antenna system.

18. A method of communicating radio frequency signals through a distributed antenna system, the method comprising:
converting a combined signal containing a respective signal from each of one or more network devices into a digital radio frequency signal;
communicating a first optical signal representing the digital radio frequency signal over a first optical communication medium to a remote unit;
converting the digital radio frequency signal recovered from the first optical signal back to the combined analog radio frequency signal in the remote unit;
communicating a second optical signal representing at least a portion of the combined analog radio frequency signal over a second optical communication medium to an antenna unit co-located with an antenna, wherein the antenna unit is not co-located with the remote unit; and
recovering the at least a portion of the combined analog radio frequency signal from the received second optical signal in the antenna unit; and
radiating, with the antenna, a signal from a frequency band in the at least a portion of the combined analog radio frequency signal recovered by the antenna unit from the second optical signal.

19. The method of claim 18, wherein the combined signal is a combined analog radio frequency signal; and
wherein the respective signal from each of one or more network devices is a respective radio frequency signal from each of one or more network devices.

20. The method of claim 19, further comprising:
receiving a plurality of radio frequency signals from a plurality of network devices; and
combining the plurality of radio frequency signals into the combined analog radio frequency signal.

21. The method of claim 18, wherein the second optical signal represents the entire spectrum of the combined analog radio frequency signal.

22. The method of claim 21, further comprising filtering the combined analog radio frequency signal recovered from the second optical signal in the antenna unit to select the frequency band corresponding to the antenna.

23. The method of claim 18, further comprising separating the combined analog radio frequency signal into a plurality of frequency bands in the remote unit, wherein the second optical signal represents the frequency band corresponding to the antenna.

24. The method of claim 18, further comprising amplifying, in the antenna unit, the frequency band in the at least a portion of the combined analog radio frequency signal recovered by the antenna unit from the second optical signal.
